(19) United States
(12) Patent Application Publication
(10) Pub. No.: US 2025/0329088 A1
(43) Pub. Date: Oct. 23, 2025

(54) PUBLISHING A WORK

(71) Applicant: Beijing Zitiao Network Technology Co., Ltd., Beijing (CN)

(72) Inventors: Weiwei Yu, Beijing (CN); Xinyu Zhang, Beijing (CN)

(21) Appl. No.: 19/173,575

(22) Filed: Apr. 8, 2025

Related U.S. Application Data
(63) Continuation of application No. PCT/CN2024/089414, filed on Apr. 23, 2024.

(51) Int. Cl. G06T 11/60; G06F 3/0484

(52) U.S. Cl. CPC G06T 11/60; G06F 3/0484

(57) ABSTRACT

Provided in the disclosure, a method, an apparatus, a device and a storage medium for publishing a work are provided. The method includes: in response to a viewing request received, presenting a viewing interface corresponding to a target capturing mode of a target application by accessing a data set associated with the target application, the viewing interface presenting a plurality of images, the plurality of images including a set of images captured through the target capturing mode of the target application; in response to a selection of at least one image in the plurality of images, presenting an editing interface; and generating a target work corresponding to the at least one image based on an editing operation received in the editing interface, and uploading the target work to a server to publish the target work within the target application.

### CROSS-REFERENCE

This application claims priority to PCT patent application PCT/CN2024/089414, entitled “Method, Apparatus, Device and Storage Media for Publishing a Work” filed on Apr. 23, 2024, the entire content of which are incorporated herein by reference.

### FIELD

Example embodiments of the present disclosure relate generally to the field of computer, and in particular to publishing a work.

### BACKGROUND

With the development of computer technology, the Internet has become an important platform for people to publish and view works. For example, people can publish their works by capturing images or uploading images.

### SUMMARY

In a first aspect of the present disclosure, a method for publishing a work is provided. The method includes: in response to a viewing request received, presenting a viewing interface corresponding to a target capturing mode of a target application by accessing a data set associated with the target application, the viewing interface presenting a plurality of images, the plurality of images including a set of images captured through the target capturing mode of the target application; in response to a selection of at least one image in the plurality of images, presenting an editing interface; and generating a target work corresponding to the at least one image based on an editing operation received in the editing interface, and uploading the target work to a server to publish the target work within the target application.

In a second aspect of the present disclosure, an apparatus for publishing a work is provided. The apparatus includes: a first presenting module configured to present, in response to a viewing request received, a viewing interface corresponding to a target capturing mode of a target application by accessing a data set associated with the target application, the viewing interface presenting a plurality of images, the plurality of images including a set of images captured through the target capturing mode of the target application; a second presenting module configured to present an editing interface in response to a selection of at least one image of the plurality of images; and a work publishing module configured to generate a target work corresponding to the at least one image based on an editing operation received in the editing interface, and upload the target work to a server to publish the target work within the target application.

In a third aspect of the present disclosure, an electronic device is provided. The device includes at least one processing unit; and at least one memory coupled to the at least one processing unit and storing instructions for execution by the at least one processing unit. The instructions, when executed by at least one processing unit, cause the device to perform the method of the first aspect.

In a fourth aspect of the present disclosure, a computer-readable storage medium is provided. A computer program is stored on the computer-readable storage medium, and the computer program can be executed by a processor to implement the method of the first aspect.

It should be understood that the content described in this Summary section is not intended to define key features or important features of the embodiments of the present disclosure, nor is it intended to limit the scope of the present disclosure. Other features of the present disclosure will become apparent from the description below.

### BRIEF DESCRIPTION OF THE DRAWINGS

The above and other features, advantages and aspects of various embodiments of the present disclosure will become more apparent with reference to the following detailed description taken in conjunction with the accompanying drawings. In the drawings, the same or similar reference numbers represent the same or similar elements, where:

FIG. 1 illustrates a schematic diagram of an example environment in which embodiments of the present disclosure can be implemented;

FIGS. 2A to 2G illustrate schematic diagrams of example interfaces of some embodiments in accordance with the present disclosure;

FIG. 3 illustrates a flowchart of a process for publishing a work in accordance with some embodiments of the present disclosure;

FIG. 4 illustrates a schematic structural block diagram of an apparatus for capturing an image in accordance with certain embodiments of the present disclosure;

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms and should not be construed as limited to the embodiments set forth herein, but rather, these embodiments are provided for a thorough and complete understanding of this present disclosure. It should be understood that the drawings and embodiments of the present disclosure are for illustrative purposes only and are not intended to limit the scope of the present disclosure.

It is important to note that heading of any section/subsection provided in this article is not limiting. Various embodiments are described throughout herein, and any type of embodiments can be included under any section/subsection. Furthermore, the embodiments described in any section/subsection may be combined in any way with any other embodiments described in the same section/subsection and/or in a different section/subsection.

In the description of embodiments of the present disclosure, the term “including” and similar expressions shall be understood as an open-ended inclusion, that is, “including but not limited to”. The term “based on” should be understood to mean “based at least in part on.” The term “an embodiment” or “the embodiment” shall be understood to mean “at least one embodiment”. The term “some embodiments” should be understood as “at least some embodiments”. Other explicit and implicit definitions may be included below. The terms “first”, “second”, etc. may refer to different or the same object. Other explicit and implicit definitions may be included below.

The embodiments of the present disclosure may involve user data, the obtaining and/or use of data, etc. These aspects comply with corresponding laws, regulations and relevant regulations. In the embodiments of this disclosure, collection, obtaining, processing, processing, forwarding, use, etc. of all data are performed with the user's knowledge and confirmation. Accordingly, when implementing each embodiment of the present disclosure, users should be informed of the type, scope of use, usage scenarios, etc. that may be involved in the data or information and obtain their authorization through appropriate means in accordance with relevant laws and regulations. The specific notification and/or authorization methods may vary according to the actual situation and application scenarios, and the scope of the present disclosure is not limited in this regard.

The technical solution in this specification and embodiments, if the processing of personal information is involved, the processing will be carried out on the premise that there is a basis of legality (e.g., consent of the subject of the personal information is obtained or it is necessary to fulfill a contract, etc.), and the processing will be carried out only within the scope of the stipulations or agreements. The user refusing to process personal information other than that which is necessary for the basic functions will not affect the user's use of the basic functions.

As mentioned above, capturing images and publishing works has become one of people's daily needs. However, the image content managed by traditional solutions is messy and the speed of retrieving images is slow, making it difficult to effectively manage images captured in different modes, which makes it difficult for users to efficiently publish works taken in specific modes.

The embodiments of the present disclosure propose a solution for publishing a work. According to the solution, in response to a viewing request received, by accessing a data set associated with a target application, a viewing interface corresponding to a target capturing mode of the target application is presented, a plurality of images are presented on the viewing interface, the plurality of images include a set of images captured by using the target capturing mode of the target application; in response to a selection of at least one image in the plurality of images, an editing interface is presented; and a target work corresponding to the at least one image is generated based on an editing operation received in the editing interface, and the target work is uploaded to a server to publish the target work within the target application.

As a result, the embodiments of the present disclosure can more effectively manage images captured in specific capturing modes. On the one hand, this helps to improve the management efficiency of storage of image information; on the other hand, by supporting creation and publication of corresponding works based on such images, the efficiency of editing and publishing works can be further improved.

Example embodiments according to the present disclosure will be further described below with reference to the accompanying drawings.

### Example Environment

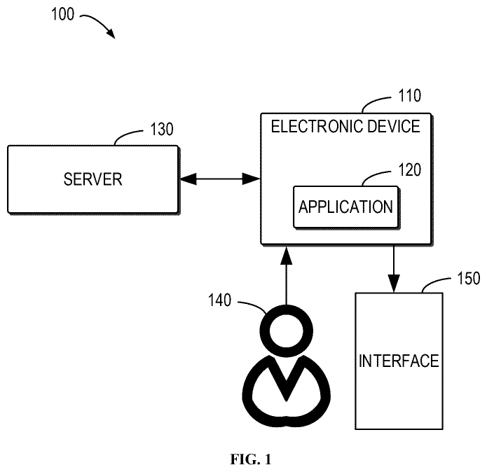

FIG. 1 illustrates a schematic diagram of an example environment 100 in which embodiments of the present disclosure can be implemented. As shown in FIG. 1, example environment 100 may include electronic device 110.

In this example environment 100, an application 120 that supports interface interaction may run on an electronic device 110. The application 120 may be any suitable type of application for interface interaction, examples of which may include but are not limited to: a camera application, a video application, an image application, or other appropriate applications. A target user 140 may interact with application 120 via the electronic device 110 and/or its attached devices.

In the environment 100 of FIG. 1, if the application 120 is in an active state, the electronic device 110 may display an interface 150 for supporting interface interaction through the application 120.

In some embodiments, the electronic device 110 communicates with the server 130 to enable provision of services to the application 120. The electronic device 110 may be any type of a mobile terminal, a fixed terminal or a portable terminal, including a mobile phone, a desktop computer, a laptop computer, a notebook computer, a netbook computer, a tablet computer, a media computer, a multimedia tablet, a palmtop computer, a portable game terminal, a VR/AR equipment, a Personal Communication System (PCS) device, a personal navigation device, a Personal Digital Assistant (PDA), an audio/video player, a digital cameras/camcorder, a positioning device, a TV receiver, a radio receiver, an e-book device, a gaming device, or any combination of the foregoing, including accessories and peripherals for these devices or any combination thereof. In some embodiments, the electronic device 110 can also support any type of interface targeted to the user (such as “wearable” circuitry, etc.).

The server 130 may be an independent physical server, or a server cluster or distributed system consisted of a plurality of physical servers, or a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server such as a mainframe, an edge computing node, a computing device in a cloud environment, or the like. The server 130 may provide background services for the applications 120 in the electronic device 110 that support interface interaction.

A communication connection may be established between the server 130 and the electronic device 110. Communication connections can be established via wired or wireless manner. Communication connections may include but are not limited to Bluetooth connections, mobile network connections, Universal Serial Bus (USB) connections, Wireless Fidelity (WIFI) connections, etc. The embodiments of the present disclosure are not limited in this regard. In the embodiments of the present disclosure, the server 130 and the electronic device 110 can implement signaling interaction through the communication connection therebetween.

It should be understood that the structure and function of various elements in environment 100 are described for illustrative purposes only and do not imply any limitation on the scope of the present disclosure.

Some example embodiments of the present disclosure will continue to be described below with reference to the accompanying drawings.

### Example Interaction

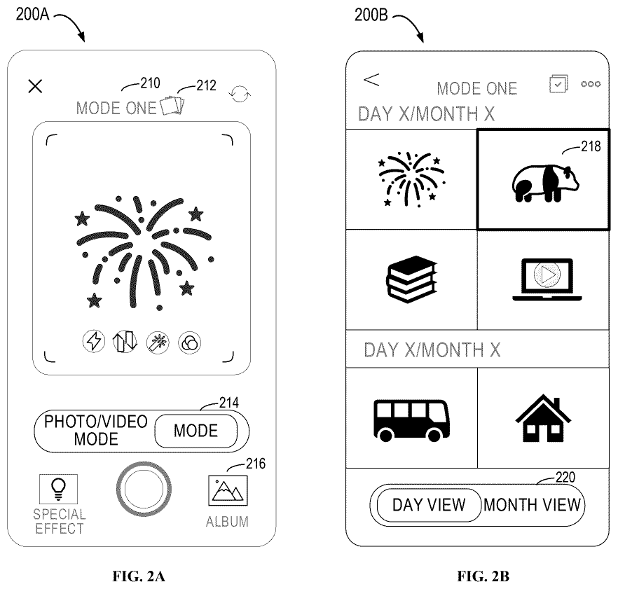

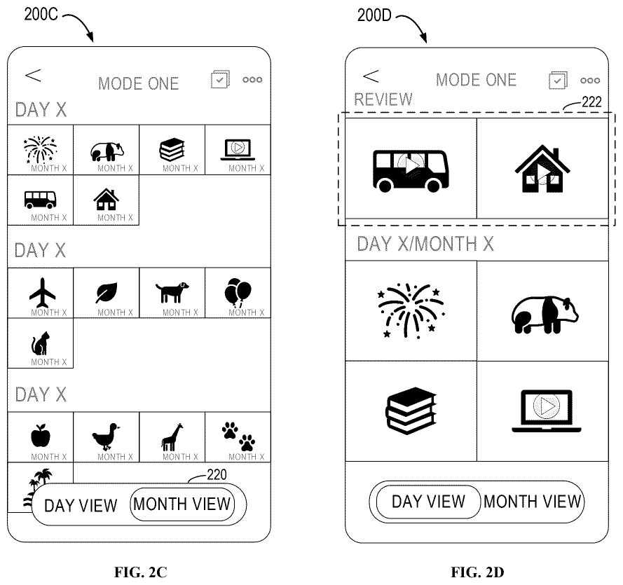

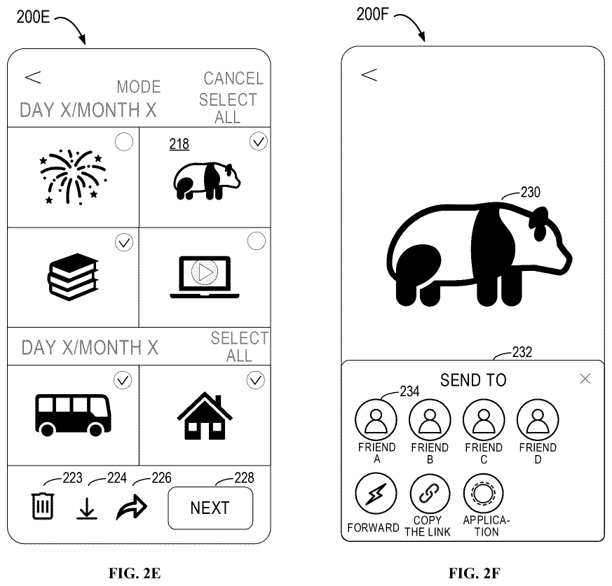

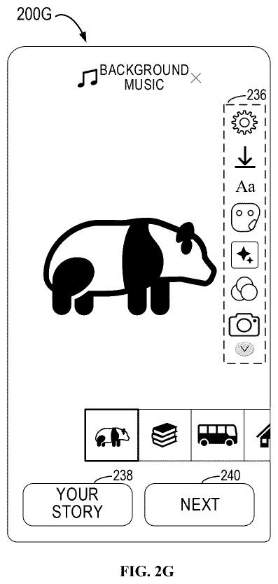

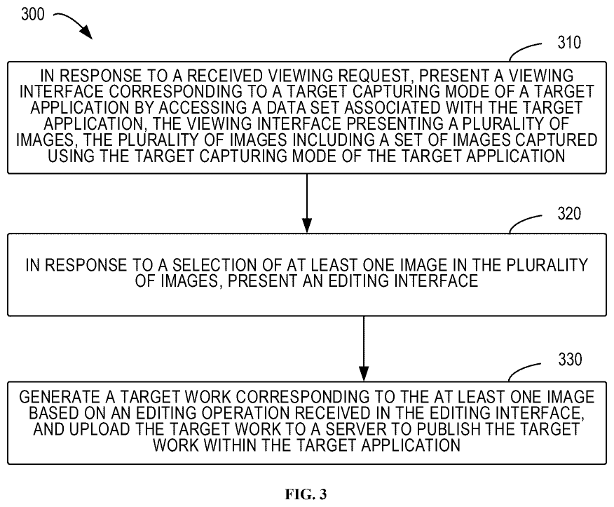

An example interaction process according to embodiments of the present disclosure will be described below with reference to FIGS. 2A to 2G. FIGS. 2A to 2G illustrate example interfaces 200A to 200I according to some embodiments of the present disclosure. The interfaces 200A to 200G may be provided, for example, by the electronic device 110 shown in FIG. 1.

As shown in FIG. 2A, the electronic device 110 may display a capturing interface 200A, for example. In some embodiments, the capturing interface 200A may be provided by a target application (e.g., the application 120) installed on the electronic device 110. For example, the electronic device 110 may present the capturing interface 200A as shown in FIG. 2A based on the capturing request of the user 140.

In some embodiments, the capturing interface 200A may correspond to a target capturing mode 210 (e.g., mode one) for capturing photos based on the capturing mode. As an example, the capturing mode may include a continuous capturing mode.

As an example, in the continuous capturing mode, the electronic device 110 may capture images based on the user's triggering of the capturing control in the interface 200A. Compared with traditional applications, after completing the capturing of the image, the electronic device 110 can continue to maintain the capturing interface 200A, and can accordingly display indication information 212 about images captured in this round of continuous shooting, such as thumbnails.

As an example, in the case where the user captures a first image based on the continuous capturing mode, the indication information 212 may include a thumbnail of the image. Further, when the user continues to capture a second image in the continuous capturing mode, the indication information 212 may be updated to present thumbnails of the two captured images.

As a result, in this capturing mode, the user can efficiently capture a plurality of images without having to consider the image editing or publishing process at this stage, thereby improving the continuity of image capturing.

In some embodiments, as shown in FIG. 2A, the electronic device 110 may also provide a control 214 for the user to switch the capturing mode to support switching the continuous capturing mode to a normal capturing mode, for example.

Additionally, the electronic device 110 can also provide a viewing entry 216 in the interface 200A, and can present the viewing interface 200B as shown in FIG. 2B by calling the data set corresponding to the target application based on the selection of the viewing entry. The viewing interface 200B may correspond to the target capturing mode to present only images captured based on the target capturing mode and/or aggregated content generated based on these images.

In some embodiments, images captured based on the target capture mode are not automatically synchronized to the electronic device 110 locally, for example. For example, the captured images can be independently managed by the target application and can be stored in the cloud, for example, and the user can be supported to freely access the captured images at different electronic devices.

As shown in FIG. 2B, in the interface 200B, the electronic device 110 may present a set of historical images 218 captured based on the target capturing mode. As an example, the set of historical images 218 may be organized in the interface according to a predetermined time granularity, for example. As shown in FIG. 2B, the set of historical images 218 may be organized by “day”, for example.

Additionally, the electronic device 110 may also provide a switch control 220. As an example, after receiving a predetermined operation on the switch control 220, the electronic device 110 may switch the display mode of the viewing interface from an organization mode by “day” as shown in FIG. 2B to an organization mode by “month” as shown in FIG. 2C. As shown in FIG. 2C, under the organization mode by “month”, images captured in the same month can be presented in association.

In some embodiments, as shown in FIG. 2D, the viewing interface 200D may also display at least one item of aggregated image content 222 generated based on a set of images captured in the target capture mode.

In some embodiments, such aggregated image content 222 may include, for example, video content generated based on a plurality of historical images associated with the same topic. For example, such aggregated image content 222 may include a review of images captured each month, or a review of images captured about a specific location, a review of images captured about a specific character, etc. It should be understood that corresponding aggregated content can also be generated based on other suitable topics.

Based on this method, the embodiments of the present disclosure can make it more convenient for users to manage images captured in the target mode.

Further, as shown in FIG. 2E, the electronic device 110 may receive a selection of at least one image 218 shown in viewing interface 200E. It should be understood that such at least one image 218 may include historical images captured by the user utilizing the target capture mode and/or the aggregated image content 222 described above.

Accordingly, the electronic device 110 may present a set of controls for performing corresponding operations on the selected at least one image 218.

For example, the set of controls may include a delete control 223 for deleting the selected at least one image 218.

Additionally, the set of controls may include a download control 224 for downloading the selected at least one image 218. As an example, upon receiving a selection of the download control 224, the selected at least one image 218 may be downloaded from the application 140 to a local photo album of the electronic device 110.

In some examples, the selected at least one image 218 may include a plurality of images. Accordingly, downloading the plurality of images may include downloading the plurality of images locally to the electronic device 110 respectively, or downloading the plurality of images may include downloading aggregated content (e.g., a single picture or video content) generated based on the plurality of images to the electronic device 110 locally.

As shown in FIG. 2E, the set of controls may also include a sharing control 226. After receiving a selection of the sharing control 226, the electronic device 110 may present an interface 200F as shown in FIG. 2F. As shown in FIG. 2F, the interface 200F may present a sharing panel 232 and provide a plurality of types of sharing entries.

As an example, the sharing panel 232 may provide a sharing entry 234 corresponding to the target user (e.g., friend A). After receiving the selection of the sharing entry 234, the electronic device 110 may send a message (e.g., a private message) generated based on the selected at least one image 218 to the target user through the application.

In some examples, the selected at least one image 218 may include a plurality of images. In some embodiments, the electronic device 110 may accordingly send a plurality of messages corresponding to the plurality of images to the target user.

In some embodiments, in order to improve the efficiency of message sharing, the electronic device 110 can also generate video content 230 based on the selected at least one image 218. As an example, the electronic device 110 may also provide a preview of video content 230 in an interface 200F.

It should be understood that corresponding video content may be generated based on the plurality of items of image contents in any suitable manner (e.g., using a predetermined template). The present disclosure is not intended to limit the specific generation process of video content.

In some embodiments, the sharing panel 232 may also provide a sharing entry for generating a link about the selected at least one image, for example. As an example, upon receiving a selection of the sharing entry, the electronic device 110 may generate an access link for accessing the generated video content 230.

Continuing to refer to FIG. 2E, the electronic device 110 may also provide a control 228, which may correspond to a sharing portal for publishing works. Further, after receiving a selection of the control 228, the electronic device 110 may present an editing interface 200G as shown in FIG. 2G.

As shown in FIG. 2G, the editing interface 200G may provide one or more editing controls 236 for editing the selected at least one image 218. As an example, the editing interface 200G may support the user to perform various appropriate types of editing operations, such as cropping, applying filters, adding materials, adjusting colors, etc. The present disclosure is not intended to limit the specific form of the editing operation.

In some embodiments, the electronic device 110 generates a work corresponding to at least one image based on an editing operation on at least one image in the editing interface, and uploads the work to the server.

In some embodiments, the electronic device 110 may provide one or more sharing entries for publishing corresponding works in the interface 200G. For example, the sharing entry 238 can support the user to quickly publish corresponding works based on the editing content of the editing interface 200G without requiring the user to input information such as title and description.

As another example, the sharing entry 240 may be used to guide to a publishing interface of a work to receive content publishing user-input, such as the title of the work, tags of the work, etc.

In the case where the selected at least one image 218 includes a single image, the published work may be a single-image work, for example. In the case where the selected at least one image 218 includes a single image, the published work may be, for example, an album work or a video work generated based on the at least one image 218.

In this way, the embodiments of the present disclosure can embed previews of a plurality of images captured in a specific capturing mode in the target application 120, and as compared to a case where only a single image is previewed at a time and an interaction between the application 120 and the operating system of the electronic device 110 is required to be performed for each image preview, resources required for interaction between the application 120 and the operating system of the electronic device 110 may be effectively saved. In addition, when publishing a work based on at least one image in the plurality of images, the present disclosure can preview the plurality of images at the same time, which can speed up the efficiency of selecting images required for publishing the work, and further improve the efficiency of publishing the work.

Based on the process described above, the embodiments of the present disclosure can more effectively manage images captured in a specific capturing mode, which is conducive to efficient screening and utilization of images, and can support the creation and publishing of corresponding works based on such images, thereby improving the efficiency of editing and publishing works.

### Sample Process

FIG. 3 illustrates a flowchart of an example process 300 for publishing a work in accordance with some embodiments of the present disclosure. The process 300 may be implemented at the electronic device 110. The process 300 is described below with reference to FIG. 1.

As shown, at block 310, in response to a viewing request received, the electronic device 110 presents a viewing interface corresponding to a target capturing mode of a target application by accessing a data set associated with the target application, the viewing interface presenting a plurality of images, the plurality of images includes a set of images captured by using the target capturing mode of the target application.

At block 320, the electronic device 110 presents an editing interface in response to a selection of at least one image of the plurality of images.

At block 330, the electronic device 110 generates a target work corresponding to at least one image based on an editing operation received in the editing interface, and uploads the target work to the server to publish the target work within the target application.

In some embodiments, the process 300 further includes: presenting a capturing interface of the target application, the capturing interface corresponding to the target capturing mode; and receiving a viewing request based on a selection of a viewing entry in the capturing interface.

In some embodiments, the viewing interface further includes a switch control. The process 300 also includes: switching an image display mode of the viewing interface from a first mode to a second mode based on a predetermined operation on the switch control, the first mode and the second mode corresponding to different time granularities, and the time granularity indicates a manner in which a set of historical images is organized in the viewing interface.

In some embodiments, the plurality of images also includes at least one item of aggregated image content generated based on the set of images captured.

In some embodiments, at least one item of aggregated image content includes video content generated based on a plurality of historical images associated with a same topic.

In some embodiments, presenting the editing interface based on the selection of at least one image in the plurality of images includes: presenting a first sharing entry based on the selection of the at least one image; and presenting the editing interface based on a selection of the first sharing entry.

In some embodiments, the process 300 further includes: presenting a second sharing entry associated with a target user; and generating, based on a selection of the second sharing entry, a message sent to the target user in content of the target application, the message being generated based on the at least one image.

In some embodiments, the process 300 further includes in response to the at least one image including a plurality of items of image content, generating video content based on the plurality of items of image content as the message.

### Example Apparatus and Device

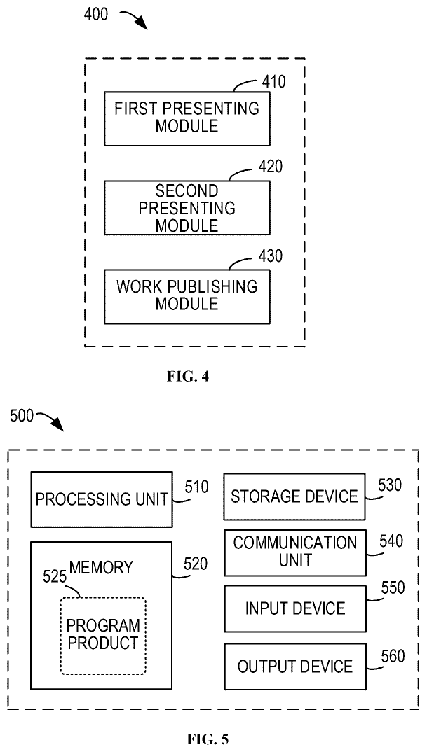

Embodiments of the present disclosure also provide a corresponding apparatus for implementing the above methods or processes. FIG. 4 illustrates a schematic structural block diagram of an apparatus 400 for publishing a work according to certain embodiments of the present disclosure. The apparatus 400 may be implemented as or included in electronic device 110. Each module/component in the device 400 may be implemented by hardware, software, firmware, or any combination thereof.

As shown in FIG. 400, the apparatus 400 includes a first presentation module 410 configured to present, in response to a viewing request received, a viewing interface corresponding to a target capturing mode of a target application by accessing a data set associated with the target application, the viewing interface presenting a plurality of images, the plurality of images including a set of images captured through the target capturing mode of the target application; a second presenting module 420 configured to present an editing interface in response to a selection of at least one image of the plurality of images; and a work publishing module 430 configured to generate a target work corresponding to the at least one image based on an editing operation received in the editing interface, and upload the target work to a server to publish the target work within the target application.

In some embodiments, the apparatus 400 further includes a receiving module configured to: present a capturing interface of the target application, the capturing interface corresponding to the target capturing mode; and receive the viewing request based on a selection of a viewing entry in the capturing interface.

In some embodiments, the viewing interface further includes a switch control, and the apparatus 400 further includes a switching module configured to switch an image display mode of the viewing interface from a first mode to a second mode based on a predetermined operation on the switch control, the first mode and the second mode corresponding to different time granularities, and the time granularity indicates a manner in which a set of historical images is organized in the viewing interface.

In some embodiments, the plurality of images also includes at least one item of aggregated image content generated based on the set of images captured.

In some embodiments, at least one item of aggregated image content includes video content generated based on a plurality of historical images associated with a same topic.

In some embodiments, the second presenting module 420 is further configured to present a first sharing entry based on the selection of the at least one image; and present the editing interface based on a selection of the first sharing entry.

In some embodiments, the apparatus 400 further includes a message sending module configured to: present a second sharing entry associated with the target user; and generate, based on a selection of the second sharing entry, a message sent to the target user in content of the target application, the message being generated based on the at least one image.

In some embodiments, the apparatus 400 further includes a message generating module configured to generate, in response to at least one image including a plurality of items of image content, video content based on the plurality of image contents as a message.

The modules included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example and not limitation, example types of hardware logic components that may be used include field programmable gate arrays (FPGAs), application specific integrated circuits (ASICs), application specific standard products (ASSPs), system-on-chip (SOCs), complex programmable logic devices (CPLDs), and the like.

FIG. 5 illustrates a block diagram of an electronic device 500 in which one or more embodiments of the present disclosure may be implemented. It should be understood that the electronic device 500 illustrated in FIG. 5 is merely example and should not constitute any limitation on the functionality and scope of the embodiments described herein. The electronic device shown in FIG. 5 may be used to implement the electronic device 110 of FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve the parallel processing capability of electronic device 500.

The electronic device 500 typically includes a plurality of computer storage media. Such media may be any available media accessible by the electronic device 500, including, but not limited to, volatile and non-volatile media, removable and non-removable media. The memory 520 may be a volatile memory (e.g., a register, a cache, a random-access memory (RAM)), a non-volatile memory (e.g., read-only memory (ROM), an electrically erasable programmable read-only memory (EEPROM), flash memory), or some combination thereof. A storage device 530 may be a removable or non-removable medium and may include a machine-readable medium, such as a flash drive, a magnetic disk, or any other medium, which may be used to store information and/or data and may be accessed within the electronic device 500.

The electronic device 500 may further include additional removable/non-removable, volatile/non-volatile storage media. Although not shown in FIG. 5, a disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communications unit 540 implements communications with other electronic devices over a communications medium. Additionally, the functionality of components of the electronic device 500 may be implemented in a single computing cluster or a plurality of computing machines capable of communicating over a communication connection. Thus, the electronic device 500 may operate in a networked environment using logical connections to one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) such as a storage device, a display device, or the like through the communication unit 540 as required, and communicate with one or more devices that enable a user to interact with the electronic device 500, or communicate with any device (e. g., a network card, a modem, or the like) that enables the electronic device 500 to communicate with one or more other electronic devices. Such communication may be performed via an input/output (I/O) interface (not shown).

According to example implementations of the present disclosure, there is provided a computer-readable storage medium having computer instructions stored thereon, where the computer instructions are executed by a processor to implement the method described above. In accordance with example implementations of the present disclosure, there is also provided a computer program product, and the computer program product is tangibly stored on a non-transient computer-readable medium and includes computer-executable instructions, and the computer-executable instructions are executed by the processor to implement the above-described method.

Aspects of the present disclosure are described herein with reference to flowcharts and/or block diagrams of methods, apparatuses, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may also be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some replaced implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is example, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for publishing a work, comprising:
in response to a received viewing request, presenting a viewing interface corresponding to a target capturing mode of a target application by accessing a data set associated with the target application, the viewing interface presenting a plurality of images, the plurality of images comprising a set of images captured using the target capturing mode of the target application;
in response to a selection of at least one image in the plurality of images, presenting an editing interface; and
generating a target work corresponding to the at least one image based on an editing operation received in the editing interface, and uploading the target work to a server to publish the target work within the target application.

2. The method of claim 1, further comprising:
presenting a capturing interface of the target application, the capturing interface corresponding to the target capturing mode; and
receiving the viewing request based on a selection of a viewing entry in the capturing interface.

3. The method of claim 1, wherein the viewing interface further comprises a switch control, and the method further comprises:
switching an image display mode of the viewing interface from a first mode to a second mode based on a predetermined operation on the switch control, the first mode and the second mode corresponding to different time granularities, and the time granularity indicates a manner in which a set of historical images is organized in the viewing interface.

4. The method of claim 1, wherein the plurality of images further comprises at least one item of aggregated image content generated based on the set of images captured.

5. The method of claim 4, wherein the at least one item of aggregated image content comprises video content generated based on a plurality of historical images associated with a same topic.

6. The method of claim 1, wherein presenting the editing interface based on the selection of the at least one image in the plurality of images comprises:
presenting a first sharing entry based on the selection of the at least one image; and
presenting the editing interface based on a selection of the first sharing entry.

7. The method of claim 6, further comprising:
presenting a second sharing entry associated with a target user; and
generating, based on a selection of the second sharing entry, a message sent to the target user in the content of the target application, the message generated based on the at least one image.

8. The method of claim 7, further comprising:
in response to the at least one image comprising a plurality of items of image content, generating video content based on the plurality of items of image content as the message.

9. An electronic device, comprising:
at least one processing unit; and
at least one memory coupled to the at least one processing unit and storing instructions for execution by the at least one processing unit, the instructions, when executed by the at least one processing unit, cause the electronic device to perform acts comprising:
in response to a received viewing request, presenting a viewing interface corresponding to a target capturing mode of a target application by accessing a data set associated with the target application, the viewing interface presenting a plurality of images, the plurality of images comprising a set of images captured using the target capturing mode of the target application;
in response to a selection of at least one image in the plurality of images, presenting an editing interface; and
generating a target work corresponding to the at least one image based on an editing operation received in the editing interface, and uploading the target work to a server to publish the target work within the target application.

10. The electronic device of claim 9, the acts further comprising:
presenting a capturing interface of the target application, the capturing interface corresponding to the target capturing mode; and
receiving the viewing request based on a selection of a viewing entry in the capturing interface.

11. The electronic device of claim 9, wherein the viewing interface further comprises a switch control, and the acts further comprise:
switching an image display mode of the viewing interface from a first mode to a second mode based on a predetermined operation on the switch control, the first mode and the second mode corresponding to different time granularities, and the time granularity indicates a manner in which a set of historical images is organized in the viewing interface.

12. The electronic device of claim 9, wherein the plurality of images further comprises at least one item of aggregated image content generated based on the set of images captured.

13. The electronic device of claim 12, wherein the at least one item of aggregated image content comprises video content generated based on a plurality of historical images associated with a same topic.

14. The electronic device of claim 9, wherein presenting the editing interface based on the selection of the at least one image in the plurality of images comprises:
presenting a first sharing entry based on the selection of the at least one image; and
presenting the editing interface based on a selection of the first sharing entry.

15. The electronic device of claim 14, the acts further comprising:
presenting a second sharing entry associated with a target user; and
generating, based on a selection of the second sharing entry, a message sent to the target user in the content of the target application, the message generated based on the at least one image.

16. The electronic device of claim 15, the acts further comprising:
in response to the at least one image comprising a plurality of items of image content, generating video content based on the plurality of items of image content as the message.

17. A non-transitory computer-readable storage medium on which a computer program is stored, the computer program, when executed by a processor, implements a method for publishing a work, comprising:
in response to a received viewing request, presenting a viewing interface corresponding to a target capturing mode of a target application by accessing a data set associated with the target application, the viewing interface presenting a plurality of images, the plurality of images comprising a set of images captured using the target capturing mode of the target application;
in response to a selection of at least one image in the plurality of images, presenting an editing interface; and
generating a target work corresponding to the at least one image based on an editing operation received in the editing interface, and uploading the target work to a server to publish the target work within the target application.

18. The non-transitory computer-readable storage medium of claim 17, the method further comprising:
presenting a capturing interface of the target application, the capturing interface corresponding to the target capturing mode; and
receiving the viewing request based on a selection of a viewing entry in the capturing interface.

19. The non-transitory computer-readable storage medium of claim 17, wherein the viewing interface further comprises a switch control, and the method further comprises:
switching an image display mode of the viewing interface from a first mode to a second mode based on a predetermined operation on the switch control, the first mode and the second mode corresponding to different time granularities, and the time granularity indicates a manner in which a set of historical images is organized in the viewing interface.

20. The non-transitory computer-readable storage medium of claim 17, wherein the plurality of images further comprises at least one item of aggregated image content generated based on the set of images captured.
